(19) United States
(12) Patent Application Publication
(10) Pub. No.: US 2006/0255044 A1
(43) Pub. Date: Nov. 16, 2006

(54) Dispensing package

(75) Inventor: Zoe Claire Wilkins, Keynsham (GB)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Graphic Packaging International, Inc.

(21) Appl. No.: 11/431,091

(22) Filed: May 9, 2006

Related U.S. Application Data
(63) Continuation of application No. PCT/GB04/04526, filed on Oct. 27, 2004.

(30) Foreign Application Priority Data
Nov. 13, 2003 (WO) PCT/GB04/04526

(51) Int. Cl. H02G 3/08; B65D 25/04

(52) U.S. Cl. 220/500; 220/3.94

(57) ABSTRACT

There is provided a paperboard carton for receiving articles in two or more layers separated by a divider pad which is secured relative to an end panel arrangement at one end of the carton. The carton has a top panel, a base panel and a pair of opposite sides. One of the side panels has a removable portion adjacent one end which when removed defines a roll out aperture for article removal when the carton is lying on said one end panel arrangement.

### CROSS-REFERENCE TO RELATED APPLICATIONS

This application is a continuation of PCT application No. PCT/GB2004/004526, filed on Oct. 27, 2004, and designating the United States of America, and which application claims priority to British application No. GB0326435.5, filed Nov. 13, 2003.

### INCORPORATION BY REFERENCE

The specifications and drawings of PCT application No. PCT/GB2004/004526, filed on Oct. 27, 2004, and British patent application No. GB0326435.5, filed on Nov. 13, 2003, are incorporated herein in their entirety, by this reference.

### FIELD OF THE INVENTION

The present invention relates to dispensing packages and more particularly, but not exclusively, those for canned products such as food and drink.

### BACKGROUND

Commonly, canned food/drink products are supplied in a shallow tray made of paperboard or corrugated board, with a shrink wrapping of plastic film. A number of these shrink wrapped trays are often stacked one above the other on a supermarket shelf. The trays are usually stacked on their widest surface which can be considered as lacking space efficiency, particularly if only one tray is on the shelf. Additionally the shrink wrap is not good for assisting in product differentiation.

In co-pending international patent application PCT/GB2003/00335 1, there is provided a paperboard carton for articles arranged in at least two layers, the carton having a top panel, a base panel, a pair of oppositely disposed side panels and a pair of oppositely disposed end panel arrangements, a divider pad being provided between the adjacent layers of articles and being secured relative to the end panel arrangement at one end, one of the side panels having a removable portion adjacent said one end so as to define a roll-out aperture for article removal when the carton is lying on said one end panel arrangement. In some embodiments one or more cuts extend partway to the adjacent end from the removable portion. Conveniently two of said cuts extend along the folds between said one side panel and the top and base panels respectively and also a transverse cut is provided at the end of the or each cut remote from the removable portion.

### SUMMARY OF THE INVENTION

According to the present invention there is provided a paperboard carton for articles arranged in at least two layers, the carton having a top panel, a base panel, a pair of oppositely disposed side panels, a pair of oppositely disposed end panel arrangements and a divider pad provided between the adjacent layers of articles and being secured relative to the end panel arrangement at one end, one of the side panels having a removable portion adjacent said one end so as to define by means of primary lines of weakness a roll-out aperture for article removal when the carton is standing on said one end panel arrangement, which removable portion has extensions which extend into the top and base panels, wherein a secondary line of weakness extends from each of the extensions to the adjacent end edge of the top and base panels respectively.

Preferably each end panel arrangement incorporates a pair of oppositely disposed main end flaps hingedly connected to the top and base panels respectively. In a preferred arrangement the start of each secondary line of weakness adjacent the extension is closer to the side edge than the end of the line of weakness at the end edge. With some embodiments each secondary line of weakness if serpentine in shape.

A further preferred feature is that each secondary line of weakness continues into the adjacent main end flap. Conveniently the continuation of each secondary line of weakness is angled back towards the side edge and terminates at a transverse T-shaped cut and also the upright of the T-shaped cut is generally parallel to the side edge and the cross-bar of the T-shaped cut is generally parallel to the end edge.

Ideally each secondary line of weakness comprises a cut having a number of breakable retaining bridges.

Preferably the divider pad is secured relative to the other end panel arrangement. In preferred embodiments the divider pad has a fold down gluing panel at the or each secured end. With a preferred arrangement the top end flap is folded down last and is adhesively secured to all its associated end flaps of its associated end panel arrangement and to its associated fold down gluing panel.

Ideally a single straight glue line effects said adhesive attachment of the top end flap to the other end flaps and gluing panel. In one such embodiment the base end flap has a central projecting area such that the straight glue line is provided in turn on one of the side end flaps, the gluing panel, the central area of the base end flaps, the gluing panel and the other side end flap.

Normally, the top panel, base panel, two side and two end panel arrangement panels are substantially rectangular but other arrangements could be envisaged.

### BRIEF DESCRIPTION OF THE DRAWINGS

An embodiment of the present invention will now be described in more detail. The description makes reference to the accompanying drawings in which:

FIG. 1 shows two paperboard blanks for producing a carton according to the present invention.

FIGS. 2 to 6 are end perspective views showing the stages of assembly of the blanks of FIG. 1 to form the carton according to the present invention.

FIG. 7 is a side perspective view of the assembled carton standing on one end.

FIG. 8 is another side perspective view of the assembled carton standing on one side with a removable portion removed to define a roll-out aperture.

FIG. 9 is an enlarged view of a detail of a preferred blank for producing a carton according to the present invention.

### DETAILED DESCRIPTION OF THE EMBODIMENT

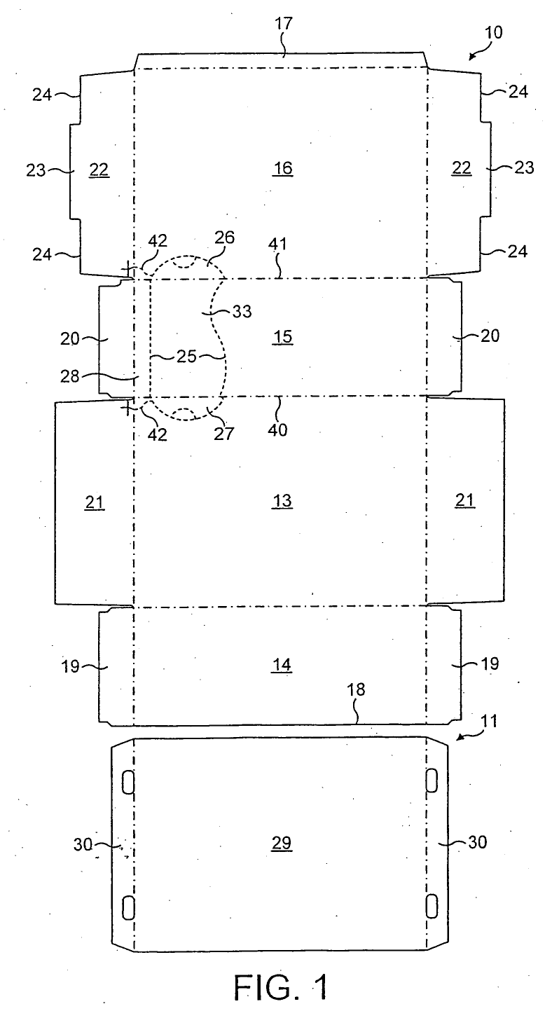

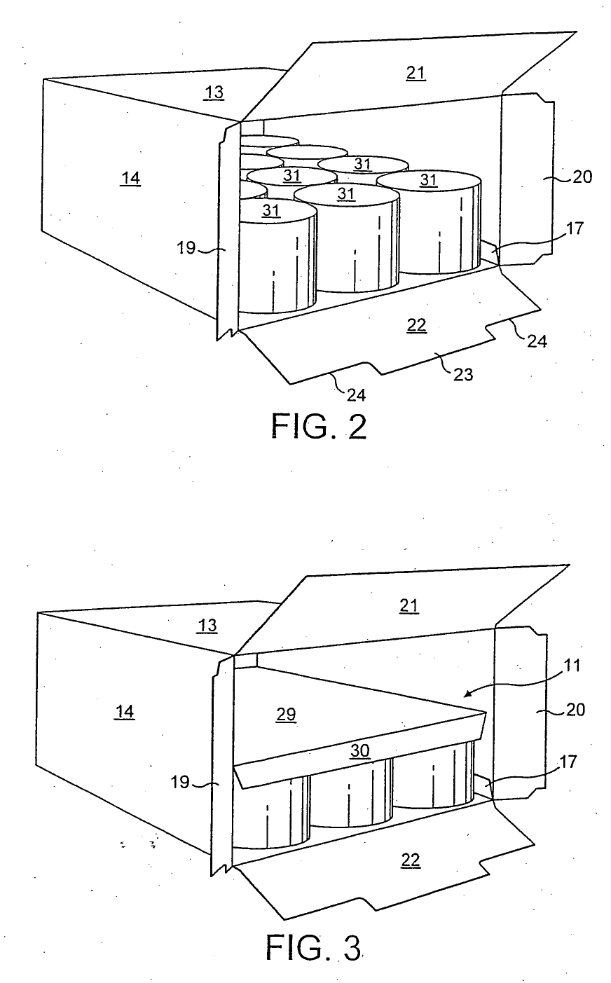

In FIG. 1 there is shown a pair of paperboard blanks 10, 11 for producing a carton 12 which is shown in FIG. 7 in an assembled condition standing on one end. The various stages of assembly are illustrated in perspective in FIGS. 2 to 6.

The main blank 10 is used to form the basic carton shape and provides a top panel 13 hingedly connected to oppositely disposed side panels 14, 15. Side panel 15 is in turn hingedly connected to a base panel 16 which is hingedly connected to an adhesive flap 17. The main blank 10 is formed into a general sleeve shape by adhering the adhesive flap 17 to the area adjacent the free edge 18 of the side panel 14.

Side end flaps 19, 20 are hingedly connected to side panels 14, 15 respectively at each end of the blank 10. A top end flap 21 is hingedly connected to the top panel 13 at each end and similarly a base end flap 22 is hingedly connected to the base panel 16 at each end of the blank 10. Each base end flap 22 has a central area 23 which projects beyond the adjacent free edges 24 of the base end flap 22 and the reason for this will be clarified later.

Side panel 15 also incorporates a removable portion 33 defined by primary lines of weakening 25 such as perforations. The removable portion 33 extends partially at 26 into the base panel 16 and at 27 into the top panel 13. A small portion 28 of the side panel 15 is intended to remain after the removable portion 33 has been removed thereby to act as a stop wall. Other forms and shapes of roll-out feature could also be substituted for the illustrated one.

The second blank 11, a divider pad, comprises a rectangular main panel 29 which corresponds in size and shape to the top and base panels 13, 16 of the main blank 10. At each end of the main panel 29 a fold-down glue panel 30 is hingedly connected.

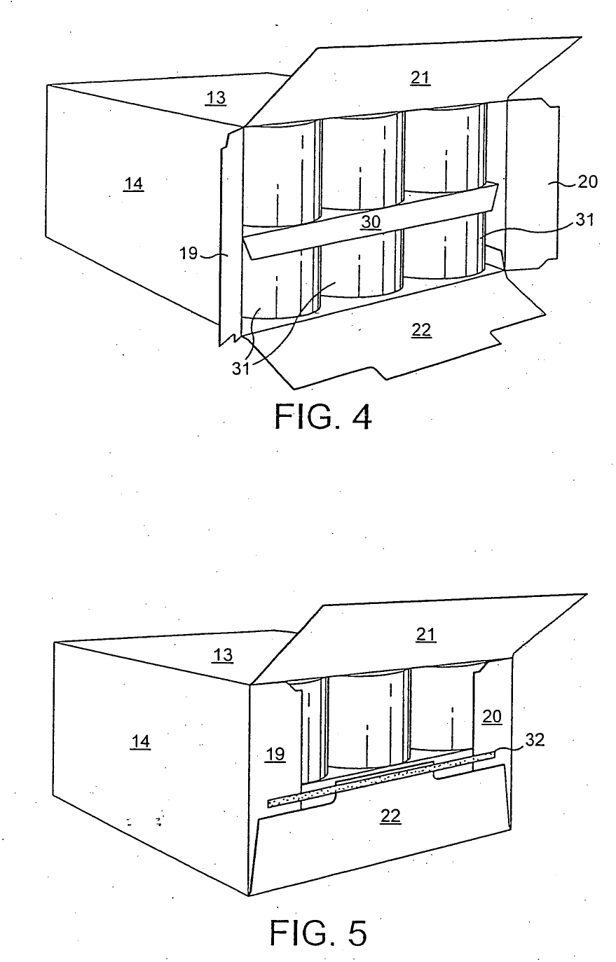

To assemble the carton 12 the adhesive flap 17 of the main blank 10 is secured to the side panel 14 and the main blank 10 is opened up to form an open-ended sleeve. A layer of cans 31 are then inserted into the sleeve so as to have their ends lying on the base panel 16 as shown in FIG. 2. The second blank 11 is then inserted as shown in FIG. 3 so as to lie on top of the layer of cans 31. A second layer of cans 31 is then inserted into the sleeve so as to lie on top of the main panel 29 of the divider pad 11 with the glue panels 30 folded down at both ends of the sleeve so as to lie against the lower layer of cans 31, as shown in FIG. 4. The side end flaps 19, 20 at each end are then folded in and the base end flaps 22 are folded up and at each end a single straight glue line 32 is applied to the side end flaps 19, 20, the glue panel 30 and to the central area 23 of the base end flap 22 as shown in FIG. 5. The top end flap 21 at each end is then folded down into contact with the glue line 32 so as to be adhesively secured to the glue panel 30, the base end flap 22 and the side end flaps 19, 20.

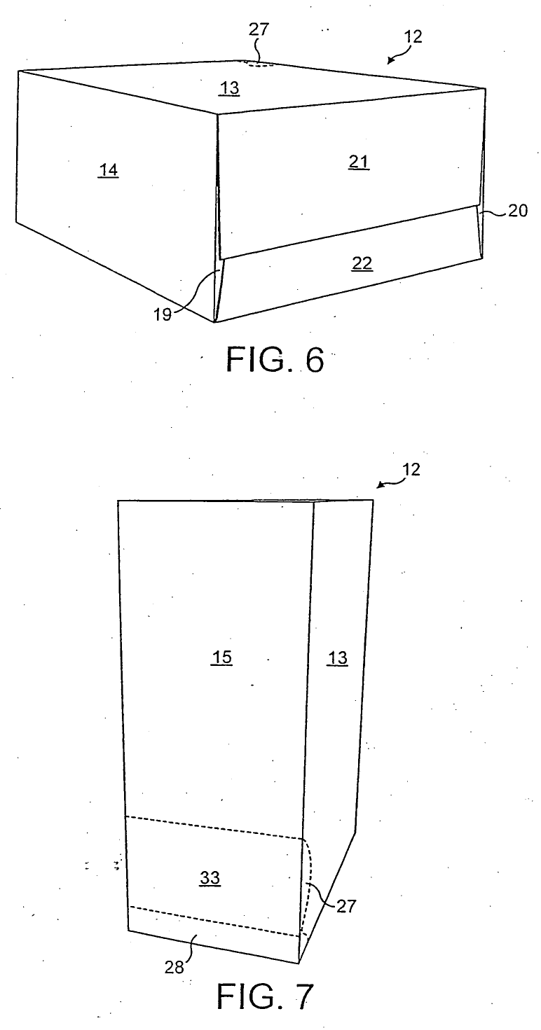

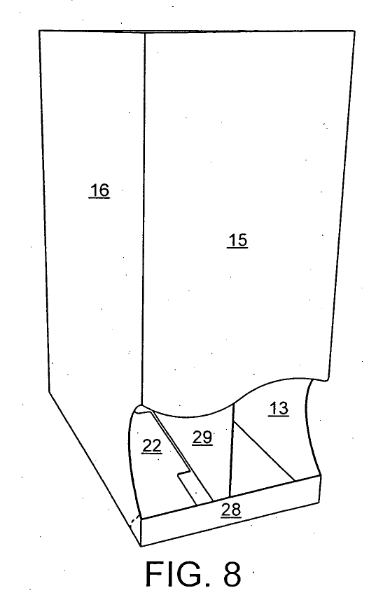

The carton 12 is thus fully assembled as shown in FIG. 6 and all panels can display product and promotion information, advertising, logos, competition details etc. In store, the carton 12 can be placed on a shelf on its end adjacent the removable portion 33 which faces toward the consumer. This is shown in FIG. 7. Side panel 15 is, therefore, particularly suited to displaying advertising logos and other information. The removable portion 33 is then removed so as to enable consumers to remove the cans 31 through the resulting roll-out dispensing aperture as shown in FIG. 8. The stop wall 28 prevents the cans 31 from rolling out of the carton 12.

The carton 12 can occupy a relatively small horizontal space on the shelf compared to conventional shrink-wrapped trays for cans and can provide significant advertising/information areas, for example on the side panel 15.

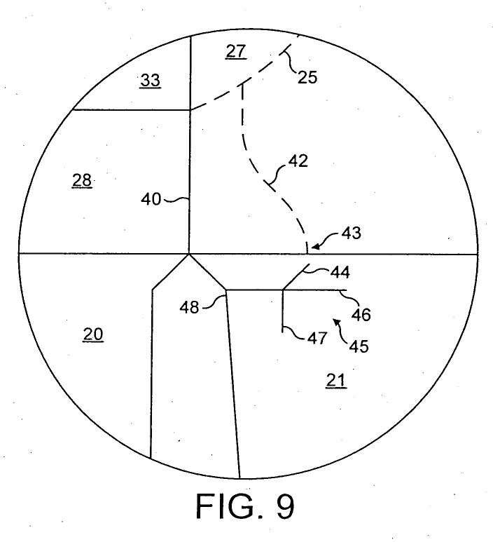

In FIG. 9 there is shown a detail which has not been discussed above. Looking at the blank detail in FIG. 9 the folds between the side panel 15 and the top panel 13 and the base panel 16 are indicated by numerals 40 and 41 respectively. The primary line of weakening 25 adjacent the stop wall 28 crosses the folds 40 and 41.

A secondary line of weakening 42 extends from the primary line of weakening 25 which defines the extensions 26 and 27 of the removable portion 33 such that there is one secondary line of weakening 42 in the top panel 13 and one in the base panel 16. Each secondary line of weakening 42 is serpentine in form and extends from a point located near the lowermost point of the removable portion when in use towards the end edge of the top/base panel where the top end flap 21/bottom end flap 22 are hingedly connected. The end 43 of the secondary line of weakening at the end fold is further from the fold 40/41 than the end adjoining the primary line of weakening 25.

This enables the lower front corner areas and the stop wall 28, on breaking of the secondary lines of weakening 42, to pivot slightly forwards generally about a line joining the ends 43. This facilitates easier removal of the cans but returns to its original shape after a can has been removed.

A further preferred feature shown in FIG. 9 is that in the end flaps 21, 22 a short angled cut 44 extends towards the fold 40/41 from just short of the area of end 43 of each secondary line of weakening 42. At the end of each angled cut 44 is a T-shaped cut 45, the cross bar 46 of which is parallel to the end fold and the upright 47 of which is parallel to the folds 40/41. Also, the cross bars 46 of the cuts 45 extend to the free edges 48 of the top end flaps 21/bottom end flap 22 respectively. This feature assists movement of the lower corner areas in use and assists in the distribution of stresses during this movement.

It will be appreciated that other products could be packaged in this way, not just cylindrical cans, although cylindrical articles are particularly well suited to the carton. In addition the carton could be modified to accommodate more than two layers of cans, each layer separated by a divider pad which is secured at least to the end panel arrangement adjacent the roll-out aperture and preferably to both end panel arrangements. Other methods of assembly of the finished carton could also be readily envisaged.

What is claimed is:

1. A paperboard carton for articles arranged in at least two layers, the carton having a top panel, a base panel, a pair of oppositely disposed side panels, a pair of oppositely disposed end panel arrangements and a divider pad provided between the adjacent layers of articles and being secured relative to the end panel arrangement at one end, one of the side panels having a removable portion adjacent said one end so as to define by means of primary lines of weakness a roll-out aperture for article removal when the carton is standing on said one end panel arrangement, which removable portion has extensions which extend into the top and base panels, wherein a secondary line of weakness extends from each of the extensions to the adjacent end edge of the top and base panels respectively.

2. A carton as claimed in claim 1 wherein each end panel arrangement incorporates a pair of oppositely disposed main end flaps hingedly connected to the top and base panels respectively.

3. A carton as claimed in claim 2 wherein the start of each secondary line of weakness adjacent the extension is closer to the side edge than the end of the line of weakness at the end edge.

4. A carton as claimed in claim 3 wherein each secondary line of weakness is serpentine in shape.

5. A carton as claimed in claim 3 wherein each secondary line of weakness continues into the adjacent main end flap.

6. A carton as claimed in claim 5 wherein the continuation of each secondary line of weakness is angled back towards the side edge and terminates at a transverse T-shaped cut.

7. A carton as claimed in claim 6 wherein the upright of the T-shaped cut is generally parallel to the side edge and the cross-bar of the T-shaped cut is generally parallel to the end edge.

8. A carton as claimed in claim 1 wherein each secondary line of weakness comprises a cut having a number of breakable retaining bridges.

9. A carton as claimed in claim 1 wherein the divider pad is secured relative to the other end panel arrangement.

10. A carton as claimed in claim 1 wherein the divider pad has a fold down gluing panel at the or each secured end.

11. A carton as claimed in claim 1 wherein the top end flap is folded down last and is adhesively secured to all its associated end flaps of its associated end panel arrangement and to its associated fold down gluing panel.

12. A carton as claimed in claim 11 wherein a single straight glue line effects said adhesive attachment of the top end flap to the other end flaps and gluing panel.

13. A carton as claimed in claim 12 wherein the base end flap has a central projecting area such that the straight glue line is provided in turn on one of the side end flaps, the gluing panel, the central area of the base end flaps, the gluing panel and the other side end flap.

14. A carton as claimed in claim 1 wherein the top panel, base panel, two side and two end panel arrangement panels are substantially rectangular.
